(19) United States
(12) Patent Application Publication
(10) Pub. No.: US 2016/0267521 A1
(43) Pub. Date: Sep. 15, 2016

(54) SYSTEMS AND METHODS FOR ELECTRONICALLY MONITORING AUDIENCE ATTENTIVENESS AND RECEPTIVENESS

(71) Applicant: YuMe, Inc., Redwood City, CA (US)

(72) Inventors: Ayyappan SANKARAN, San Jose, CA (US); Jayant KADAMBI, Palo Alto, CA (US); Ayusman SARANGI, Mountain View, CA (US); Halim DAMERDJI, Los Altos, CA (US)

(21) Appl. No.: 15/031,685

(22) PCT Filed: Nov. 6, 2014
(86) PCT No.: PCT/US14/64444

§ 371 Date: Apr. 22, 2016

Related U.S. Application Data
(60) Provisional application No. 61/900,951, filed on Nov. 6, 2013.
(60) Provisional application No. 61/900,957, filed on Nov. 6, 2013.
(60) Provisional application No. 61/900,955, filed on Nov. 6, 2013.

(51) Int. Cl. G06Q 30/02

(52) U.S. Cl. CPC G06Q 30/0242; G06Q 30/0277

(57) ABSTRACT

A system and method for electronically monitoring audience attentiveness and receptiveness including: collecting user data concerning a running of and interaction with, media content received via the first network interface by a user of the network terminal; converting the collected user data into user metrics; and analyzing the data to create at least one user Brand Affinity Index (BAI) score for the network terminal user.

### FIELD

This invention relates generally to systems and methods for electronically delivering media content, and more particularly to systems and methods for monitoring users of connected devices for their receptivity to receiving media content.

### BACKGROUND

Electronic commerce, often known as “e-commerce”, includes the buying, selling and advertising of products, services and brands over electronic systems such as the Internet. The amount of trade conducted electronically has grown immensely with the widespread adoption of Internet technology. One particularly explosive area of growth in e-commerce is in the field of advertising and, in particular, video advertising on the Internet.

Advertising is a common way or seller of goods and/or services to generate sales and/or to initiate, maintain and increase brand awareness. In traditional media, such as television and print media, an advertisement may be seen by a wide demographic audience. Generally, only a small percentage of the audience will have any interest in purchasing the goods or services. Also, with traditional media, there is typically a limited supply of space for advertisements. In the art, the amount of resources (e.g., physical space, time, etc.) available for advertising is sometimes referred to as “inventory.”

The inherent nature of the Internet is that it creates ever-increasing amounts of advertising inventory. This is because web technology can generate an advertising message image (called an “impression”) each time a web page (or other, for example, html based platform) is accessed. Since multiple users can access Internet content simultaneously, and since the number of Internet users and web pages is constantly increasing, the “inventory” of advertising space on the Internet is almost limitless.

In order to optimize their advertising investment, online advertisers try to choose among the immense inventory available so as to place their video advertisements for optimal results. This can be a hit-or-miss process whereby brand managers assume certain demographics for their ideal audience (e.g. males ages 18-35 who like fast cars) and then choose publishers that cater to that demographic profile (e.g. a website dedicated to reviewing race cars). However, this does not entirely address the ultimate goal of most brand advertisers: i.e. not only making the right placement for their advertisement but also reaching the right audience at the right time.

In today's connected world of devices, most of consumers' media time is spent in front of four video screens, namely their computer, smartphone, tablet and television screens. As used herein, the term “screen” may be used synonymously with a “user device” and “terminal” The screens users want to use depend upon the context of where they are located (workplace, home, travelling, etc.), what we they want to achieve (shop, make travel plans, watch video, etc.) and how long will it take to achieve their desired results.

Google in The New Multi-screen World: Understanding Cross-platform Consumer Behavior, dated August 2012, and hereafter referred to as Google Multi-Screen, calls this phenomenon as “the new multi-screen world” As explained in Google Multi-Screen, there are at least two different modes of consumer's behavior in context of multi-screen usage, namely: 1) sequential screening as a user moves between screens; and 2) Simultaneous screening where we use multiple screens at the same time.

The multiscreen phenomenon is very familiar in many family homes. For example, if a family is all in television room and the television is on, some or all of the family members are likely also using Internet connected mobile devices. For example, family members are likely using their smartphones for such activities as texting or emailing, or surfing the Internet on their tablets, or playing a game or doing work on their laptops. As a result, the attention to television and to television advertisements has declined.

Due to this device fragmentation & diversion of attention to mobile and CTV, advertising has become challenging for brands, and their ability to reach an attentive, receptive audience at TV scale has become far more difficult. Furthermore, there is increasing evidence that the multiscreen phenomenon increases the incidences of attention deficit disorder (ADD), whereby viewers are unable to focus their full attention on one screen for extended periods of time.

This shift in digital viewing has caused a dramatic fragmentation of content. Thirty years ago, content was delivered on four or five broadcast television channels. It then moved to hundreds of channels with the advent of cable television. Now, content is being delivered by tens of thousands of Internet “channels.” This makes it difficult for advertisers to efficiently reach a large “TV-scale” audience.

In addition to content fragmentation, screen fragmentation has increased; the average number of devices used by a person has doubled from two in 2000 to four in 2012. Screen fragmentation affects frequency quality, because no longer are viewers watching advertisements on the same TV and paying attention at all times. Therefore, most of the screens are mobile devices. To compound matters, the devices are typically based on different technologies, e.g. different operating systems, user interfaces and hardware.

This is also the problem of data fragmentation. In search and display advertising, though the amount of data volume was large, the focus was only on one piece of data, e.g. the “click” on a button or hyperlink. With video and the increase in complexity due to sight, sound and motion, the volume, variety and velocity of data has increased. Content is viewed on apps and in browsers. The video may be viewed on a smartphone or tablet, and could be on an iOS or Android operating system. Finally, the action a person takes with video is different data. For example; when someone swipes a video or clicks on a TV remote, or waves a hand in front of a Samsung Galaxy G4®, these things all need to be analyzed and processed to help find brand receptive, attentive viewers. All of these different pieces of data mean different things to brand advertisers and must be analyzed to provide a receptive, attentive audience at scale.

Consumer viewing habits are trending inexorably towards online and more specifically to mobility. As a result of these changes in viewing behavior, the TV advertising market is being disrupted. This is not the first time markets have been disrupted by changing consumer behavior, newspapers have moved to the web, and the yellow pages have been affected by search, real-estate has moved to the web. But unlike in other markets, where solutions have been created, the challenge of finding a receptive, attentive audience in a multi-device, fragmenting world has not yet been addressed by a solution.

These and other limitations of the prior art will become apparent to those of skill in the art upon a reading of the following descriptions and a study of the several figures of the drawing.

### SUMMARY

Various examples are set forth herein for the purpose of illustrating various combinations of elements and acts within the scope of the disclosures of the specification and drawings. As will be apparent to those of skill in the art, other combinations of elements and acts, and variations thereof, are also supported herein.

In a non-limiting example, tracking software or “SDK” is embedded in user devices that run video ads. Data concerning the running and interaction of the video ads is collected to determine the receptiveness and attentiveness of the users of the devices to the video ads. This data is converted into metrics which can be analyzed to create a Brand Affinity Index or BAI score. The BAI scores can then be used to present the right ad to the right screen at the right time with the goal of achieving a brand campaign with a reach and frequency that rivals a TV-scale audience.

In an embodiment, set forth by way of example and not limitation, system for electronically monitoring audience attentiveness and receptiveness includes a network terminal and an analysis server. In this example, the network terminal has a first digital processor, a first non-transient computer readable media, and a first network interface, where the first computer readable media includes program instructions executable on the first digital processor for: collecting user data concerning a running of, and interaction with, content received via the first network interface by a user of the network terminal; and transmitting the collected user data via the first network interface to an analysis server. Also in this example, the analysis server includes a second digital processor, a second non-transient computer readable media, and a second network interface, the second computer readable media including program instructions executable on the second digital processor for: receiving the collected user data via the second network interface; converting the collected user data into user metrics; and analyzing the data to create at least one user Brand Affinity Index (BAI) score for the network terminal user.

In an embodiment, set forth by way of example and not limitation, a computer-implemented method for electronically monitoring audience attentiveness and receptiveness includes: collecting user data concerning a running of, and interaction with, media content received via the first network interface by a user of the network terminal; converting the collected user data into user metrics; and analyzing the data to create at least one user Brand Affinity Index (BAI) score for the network terminal user.

An advantage of various example embodiments disclosed herein is that the viewing experiences of audiences (as measured by their attentiveness and receptiveness to such viewing experiences) is enhanced by delivering the right media content to the the right audience at the right time.

These and other examples of combinations of elements and acts supported herein as well as advantages thereof will become apparent to those of skill in the art upon a reading of the following descriptions and a study of the several figures of the drawing.

### BRIEF DESCRIPTION OF DRAWINGS

Several examples will now be described with reference to the drawings, wherein like elements and/or acts are provided with like reference numerals. The examples are intended to illustrate, not limit, concepts disclosed herein. The drawings include the following figures:

FIG. 1 illustrates an example system supporting a receptivity and attentiveness (“Brand Affinity”) scoring process;

FIG. 2 is a block diagram of an example computer, computerized device, proxy and/or server which may form a part of the system of FIG. 1;

FIG. 3 is a block diagram of an example receptivity and attentiveness scoring system;

FIG. 4 is a state diagram of an example receptivity and attentiveness scoring process;

FIG. 5 is a flow diagram of an example scoring database update process; and

FIG. 6 is a block diagram of an example ad fulfillment system which can implement a network terminal or “client device” identification process

### DESCRIPTION OF EMBODIMENTS

Brand advertising is about reach and frequency. Reach is the number of people or households watching an advertisement. Frequency is the number of times people see the advertisement. Systems and methods are disclosed herein to increase reach and frequency by measuring and analyzing the metrics of receptivity and attentiveness. As used herein, “receptivity” means how receptive a person is to the message of the video advertisement and “attention” means how attentive the person is to the video advertisement in the context (e.g. time, place, application), that it is being presented. Collectively, the combination of receptivity and attention (i.e. the right audience at the right time) will be referred to as “Brand Affinity.”

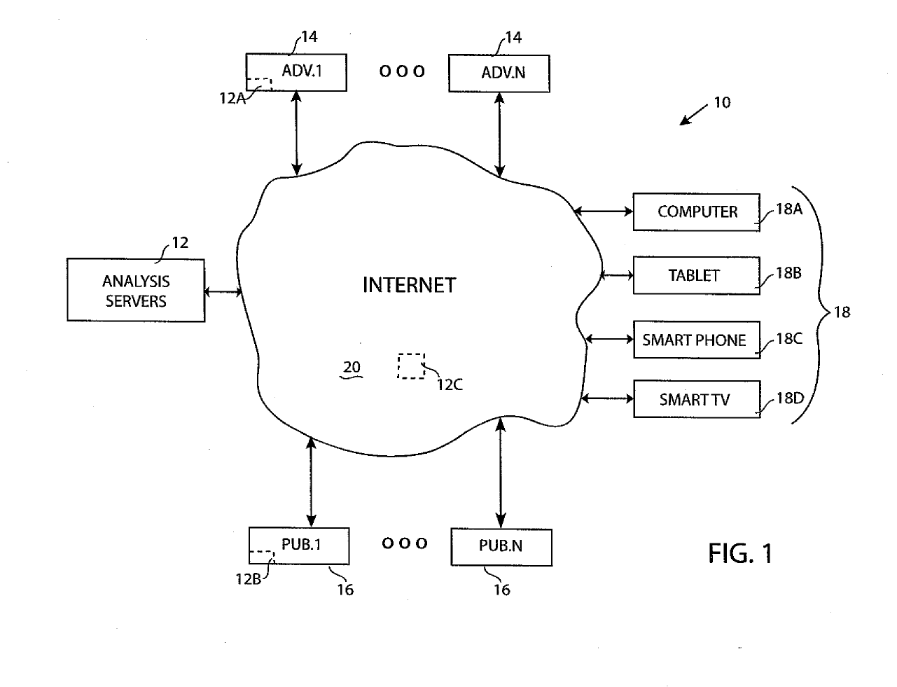

FIG. 1 illustrates a system 10, set forth by way of example and not limitation, for supporting a receptiveness and attentiveness (Brand Affinity) scoring process, referred to herein as a “Brand Affinity Index” (BAD. In this example, the network system 10 includes one or more analysis servers 12, one or more advertiser servers 14 and one or more publisher servers 16. The system at 10 may further include other computers, servers or computerized systems such as user devices 18. In this example, the analysis servers 12, advertiser servers 14, publisher servers 16, and user devices 18 can communicate by a wide area network such as the Internet 20 (also known as a “global network” or a “wide area network” or “WAN” operating with TCP/IP packet protocols).

The analysis servers 12 can be implemented as a single server or as a number of servers, such as a server farm and/or virtual servers, as will be appreciated by those of skill in the art. Alternatively, the functionality of the analysis servers 12 may be implemented elsewhere in the network system 10 such as on an advertiser server 14, as indicated at 12A, on the publisher server 16, as indicated at 12B, or as part as cloud computing as indicated at 12C, all being non-limiting examples. As will be appreciated by those of skill in the art, the processes of analysis servers 12 may be distributed within network system 10.

In the example of FIG. 1, the network system 10 includes a plurality of advertiser servers 14 {ADV. 1, ADV. 2, . . . , ADV. N}. ADV. 1 can be, for example, a manufacturer of soft drinks, ADV. 2 can be a computer manufacturer and ADV. N can be, for example, an accounting firm. Alternatively, an advertiser can be an advertising agency acting as a middleman in the purchase of advertising for a client, can be an advertising (“ad”) network, or be an ad exchange. While each of the advertiser servers 14 may be implemented as a single computer, such as a network server, they can also represent other computer configurations, such as a computing cluster on a local area network (LAN).

The publisher servers 16 can each represent one or more servers, such as a server farm. In the example of FIG. 1, the network system 10 includes a plurality of publisher servers 16 {PUB. 1, PUB. 2, . . . , PUB. M}. For example, PUB. 1 can be an Internet portal, PUB. 2 can be a search engine, and PUB. M can be a news website. As noted previously, one or more of the publisher servers 16 can implement some or all of the functionality of analysis servers 12.

It should be noted that the selection of publishers can be enhanced by categorizing the publishers by, for example, content. That is, a “publisher” can be a single legal entity, or a subset of that entity, or a part of a group of entities, by way of several non-limiting examples. For example, a publisher entity may have 1000 publications of which 100 are directed to dramatic content, 100 are directed to comedy, etc. The subset of publications of the publisher entity having a common thematic content may be considered a “publisher.” Furthermore, “publishers” may include a group of publications provided by different agencies which conform to a theme such as, by way of non-limiting examples, drama, sports or entertainment.

User devices 18 can be any type of terminal, screen or device including, by way of non-limiting examples, a computer 18A, a connected TV (a/k/a Smart TV or CTV) 18D, a tablet 18B and a smartphone 18C. The distinguishing characteristics of user devices 18 include connectivity to the Internet 20 (“connected devices”) and display screens which can display, for example, advertisements delivered to the user devices over the Internet. Some connected devices are relatively immobile (e.g. CTV 18D), while other connected devices are considered to be “mobile devices”, e.g. table 18B and smartphone 18C. By further examples, computer 18A may be a “mobile device” if it is a laptop computer but a relatively immobile device if it is a desktop computer.

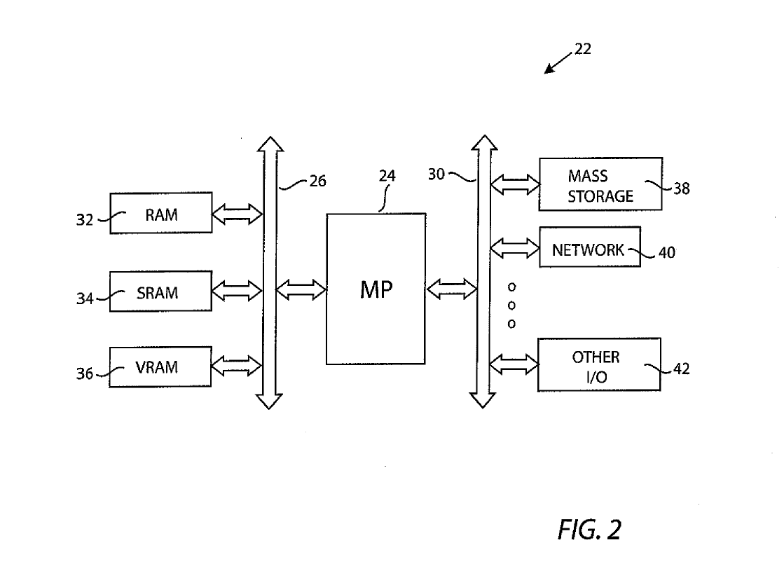

FIG. 2 is a simplified block diagram of a computer and/or server 22 suitable for use in system 10. By way of non-limiting example, computer 22 includes a microprocessor (a/k/a “processor” or “digital processor”) 24 coupled to a memory bus 26 and an input/output (I/O) bus 30. A number of memory and/or other high speed devices may be coupled to memory bus 26 such as the RAM 32, SRAM 34 and VRAM 36. Attached to the I/O bus 30 are various I/O devices such as mass storage 38, network interface 40, and other I/O 42. As will be appreciated by those of skill in the art, there are a number of non-transient computer readable media available to the microprocessor 24 such as the RAM 32, SRAM 34, VRAM 36 and mass storage 38. The network interface 40 and other I/O 42 also may include computer readable media such as registers, caches, buffers, etc. Mass storage 38 can be of various types including hard disk drives, optical drives and flash drives, to name a few.

It should be noted that the selection of publishers can be enhanced by categorizing the publishers by, for example, content. That is, a “publisher” can be a single legal entity, or a subset of that entity, or a part of a group of entities, by way of several non-limiting examples. For example, a publisher entity may have 1000 publications of which 100 are directed to dramatic content, 100 are directed to comedy, etc. The subset of publications of the publisher entity having a common thematic content may be considered a “publisher.” Furthermore, “publishers” may include a group of publications provided by different agencies which conform to a theme such as, by way of non-limiting examples, drama, sports or entertainment.

It should further be noted that, in some instances, an ad network is, essentially, transparent to advertisers, publishers or both. That is, an ad network may be considered to be a publisher or collection of publishers to an advertiser and/or an ad network may be considered to be an advertiser or collection of advertisers to a publisher.

In an embodiment, set forth by way of example and not limitation, software can be provided in each user device 18 to derive metrics, for example, concerning receptivity and attentiveness. For example, YuMe, Inc. of Redwood City, Calif. embeds software known as a “Software Developer Kit” (SDK) into user devices such as CTVs, smartphones, tablets and personal computers (PCs). These multi-screen SDKs are paired often with video ad serving technology to comprise a YuMe® OS. These “audience aware” SDKs, embedded into publisher video players, developer apps and CE manufacturer devices, collect valuable real-time, continuous, screen-level data that can be saved and aggregate into a central decision-making engine, such as on an analysis server 12, where they can be analyzed, filtered, and processed to provide real-time, actionable metrics. These metrics can include user/household identities, contexts (e.g. what application or “app” is being used) and time. Other common metrics are location (via GPS services), interactivity with the screen, etc.

By way of non-limiting example, if a user closes an application repeatedly when a diaper ad is displayed on a user device, the receptivity of that user to diaper commercials can be considered to be low. As another example, if the user interacts with the ad such as by a swipe on a tablet, the use of a remote control movement on a CTV, etc., it can be assumed that the user's receptivity is both high to diaper ads and that the user is being attentive to that ad. In other times or places, such as during work hours at work, the user may be just as receptive to the ad, but not attentive. Attentiveness can also be determined by such metrics as whether there is another multiscreen device being used by the user at the time that the video ad is playing, by using eye-tracking technology.

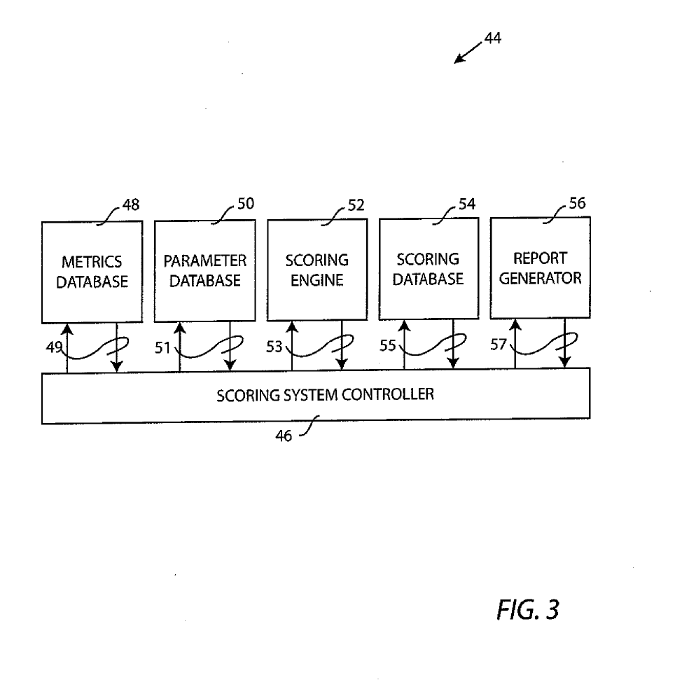

In FIG. 3, a block diagram of an example receptivity and attentiveness scoring system 14 includes a scoring system controller 46, a metrics database 48, a parameter database 50, a scoring engine 52, a scoring database 54 and a report generator 56. It should be noted that the various elements of scoring system 14 may be real and/or virtual and some or all of the elements may comprise computer implements processes.

In this example, the video advertisement may be associated an application or “app” on a user's mobile device. Typically, the video advertisement includes a “play” button which, when activated by the click of a mouse, will start to play the video advertisement (this is referred to herein as a “click-through”). Also typically, the video advertisement can be played to completion or stopped before completion. The amount of the video advertisement which is played is referred to herein as “play-through”, and may be measured in, for example, as percentages (e.g. Video Completion Rate or “VCR”) or in seconds. In some cases, the video advertisement can include links to other resources to provide additional information, content, the ability to order a product, or feeds which can enhance the video advertisement experience, by way of non-limiting examples. The embedded SDK can monitor and report such activity for later analysis concerning user receptivity and attentiveness.

In the example of FIG. 3, metrics derived from embedded SDKs can be stored in metrics database 48 for concurrent and/or subsequent analysis. The metrics database 48 may be localized and/or distributed and may be found, in part or in whole, in various locations in the example system of FIG. 1, by way of non-limiting examples. Scoring system controller 46 can engage in bidirectional communication with the metrics database 48 as indicated at 49.

A parameter database 50 can also be seen in the example of FIG. 3. Parameter database 50 can include weighting factors for metrics of the metric database 48. The parameter database 50 may be localized and/or distributed and may be found, in part or in whole, in various locations in the example system of FIG. 1, by way of non-limiting examples. Scoring system controller 46 can engage in bidirectional communication with the parameter database 50 as indicated at 51. Furthermore, the metrics database 48 and parameter database 50 may be integrated as a unified real and/or virtual database or may be linked as real and/or virtual databases.

Scoring system 44, in this example, further includes a scoring engine 52 which can be used to generate a score associate with an Internet receptivity and attentiveness. In the present example, scoring engine 52 operates on one or more metrics derived from metrics database 48 to develop a score which can characterize the receptivity and attentiveness. If the scores thus derived are directly related to the receptivity and attentiveness, the score can be considered to be a Brand Affinity Score or BAI. By developing standardized BAI scores for the purpose of making advertising decisions and/or making improvements, the “quality” of the receptivity and attentiveness can be increased for brand managers. Scoring engine 52 is, in this example, in bidirectional communication with scoring system controller 46 as indicated at 53.

Scores developed by scoring engine 52 may be stored in a scoring database 54 which, in this example, is in bidirectional communication with scoring system controller 46 as indicated at 55. The scoring database 54 may be localized and/or distributed and may be found, in part or in whole, in various locations in the example system of FIG. 1. Furthermore, the scoring database 54, metrics database 48 and parameter database 50 may be integrated as a unified real and/or virtual database or may be linked as real and/or virtual databases. By “database” it is meant herein any ordered storage of data allowing for its systematic retrieval. For example, a database may be a flat database, a table, a relational database, etc.

Report generator 56 is, in this example, coupled to scoring system controller 46 for bidirectional communication as indicated at 57. Report generator 56 may be used, for example, to create reports derived from data in the scoring database 54 or elsewhere.

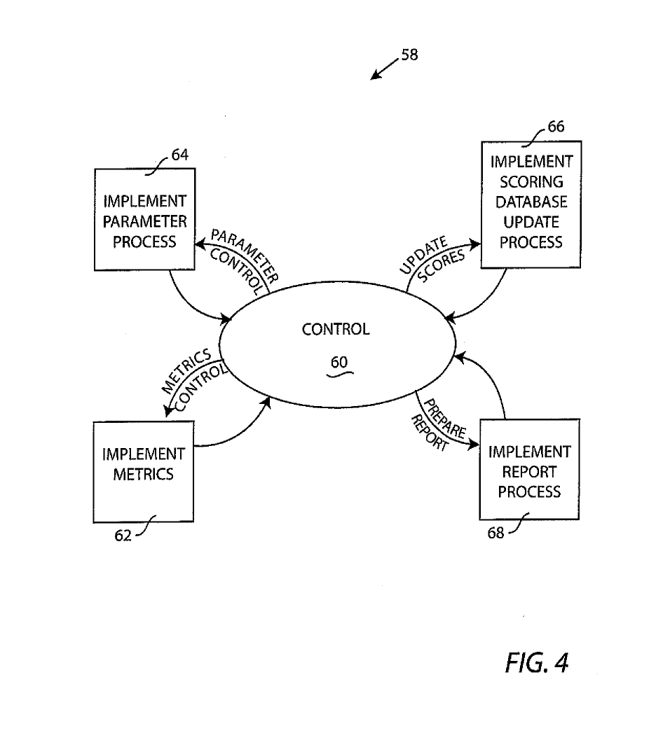

In FIG. 4, a state diagram of an example receptivity and attentiveness scoring process 58 includes a central control process 60, a metrics process 62, a parameter process 64, a scoring database update process 66 and a report process 68. Central control 60, in this example, can implement a metrics process 62, such as retrieving stored metrics from the metrics database 48 (see FIG. 3). Likewise, central control 60, by way of example, can implement parameter process 64, such as storing weights and/or demographic parameters in, for example, parameter database 50. Central control 60 can also implement a scoring database update process 66 and/or an implement report process 68 on, for example, scoring engine 52 and/or report generator 56, respectively, of FIG. 3.

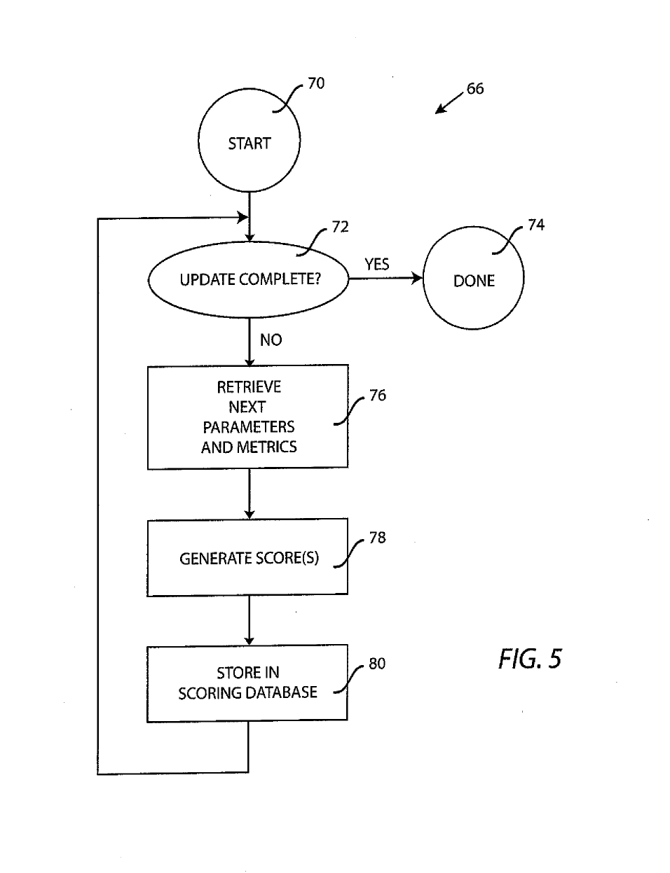

In FIG. 5, an example scoring update process 66 of FIG. 4 is illustrated in greater detail. Process 66 begins at 70 and, in a computer implemented act or “operation” 72, it is determined if the update process is complete. If it is, process 66 is done as indicated at 74 and process control returns to central control 60 (see FIG. 4). If not, the next parameters and metrics are retrieved in an operation 74. An operation 78 then generates one or more scores, which are stored in, for example, the scoring database (see FIG. 3) in an operation 80.

Generating BAI Quality Scores

BAT quality scores may be generated, by way of non-limiting example, using a weight function. A weight function is a mathematical technique used when performing, for example, a sum, integral or average in order to give some elements more “weight” or influence on the result than the other elements in the same set. In this example, the elements of a set are selected from metrics associated with an audience segment and the weights are either constants or functions associated with the receptivity and attentiveness and, in certain examples, associated demographics.

One type of weight function is the weighed sum, as given by Equation 1, below:

Σᵢ₌₁ⁿf(i)m(i) Equation 1

Where m(i) is the i^{th} metric of n selected metrics and f(i) is a weighting function associated with the metric m(i). The weighting function can be, as noted above, a constant stored in, for example, an array, table or other data structure in the parameter database 50. Alternatively, f(i) can be a function of a number of constants and/or variables, including demographic variables, which also can also be, for example, stored in parameter database′50.

Another form of weight function is the weighted average. Weighted averages or “weighted means” are commonly used in statistics to compensate for the presence of bias. The weighted mean is similar to the arithmetic mean (the most common type of “average”) except instead of the metrics contributing equally to the final average, some metrics contribute more than other. The notion of weighted mean plays a role in descriptive statistics and also occurs in a more general form in several other areas of mathematics. As is well known to those skilled in the art, there are other forms of weighted means, including weighted geometric means and weighted harmonic means.

Once a raw quality score is obtained, it may be normalized to be more easily compared by human analysts. For example, if the raw quality scores are in the range of 0 to 1, they may be normalized to range from 0 to 100 by multiplying by 100. Normalized scores tend to be easier for the human brain to retain and compare.

Given a sufficiently large scoring database 66, an artificial neural network can also be trained to provide quality scores. An artificial neural network (ANN), often referred simply to a “neural network”, is a computational model which simulates the structural and/or functional aspects, of biological neural networks. Neural networks include an interconnected group of artificial neurons and process information using a connectionist approach to computation. In most cases, neural networks are adaptive systems that change their structures based upon external or internal information that flows through the network during the learning phase. Most neural networks are non-linear statistical data modeling tools which can be used to model complex relationships between inputs and outputs or to find patterns in data.

In order to be properly “trained”, many examples should be applied to the neural net during the training phase. For a particular receptivity and attentiveness, the metrics and parameters are applied to inputs of the neural net, and the quality score, as stored in the scoring database 54, is applied to the output. The neural network then internally adjusts the “weights” of its neurons such that the output is a weighted function of the inputs. After many examples the neural net “learns” how to generate the proper quality score based upon any arbitrary set of inputs.

An advantage of a trained neural network is that it is not necessary to know how the correct answer is derived. In fact, many more metrics can be input into a neural network than could be conveniently handled by human-assisted calculations. This has the advantage of increased robustness and the possibility of the neural network “discovering” transfer function relationships not considered by human designers. Once properly trained, a neural network can operate without any human interaction with respect to the selection of weights for a weight function.

For a new system, e.g. a system where the scoring database has not yet been started, it is preferable to start with a simple weight function scoring engine where a human operator chooses a few metrics to follow and assigns weight constants to those metrics based upon expert knowledge and, to a degree, human intuition. The weights are all fractions, and the sum of the weights is “1.” As the scoring database is populated and additional experience is accumulated, the weight constants can be adjusted by changing the weights and/or additional metrics can be added. In addition, weight functions can be selectively assigned and different sets of weights can be associated with different demographics or “demos.” For example, one set of weights can be associated for the audience segment of male viewers and another set of weights can be associated with the audience segment of female viewers.

The scoring engine 52 can therefore become increasingly sophisticated and accurate through incremental human intervention. However, at some point the interrelationships between a many potential metric and parameters may limit the sophistication of the scoring engine 52. At that point, if a sufficiently large scoring database 54 has been developed, the scoring engine 54 may be supplemented by, or replaced with, a neural network.

It should be noted that the examples set forth above for scoring engine 52 are not exhaustive of potential technologies. For example, the scoring engine can also be implemented using expert system technologies. Furthermore, scoring engine performance may be an interactive process with other inputs, processes and systems.

Homogeneous Metrics Example

The following example illustrates a generation of BAI by, for example, scoring engine 52 implementing a weight function. Suppose that, for a particular receptivity and attentiveness, such as on a web page, two metrics are tracked: 1) a click-through rate of 5%; and 2) a view-through rate of 75%. Also, further assume that the weight of the click-through rate (CTR) is 0.6 and the weight of the view-through rate (VCR) is 0.4, i.e. click-through is weighted more heavily in this example than view-through rate. Using Equation 1, the BAI for the receptivity and attentiveness as a weighted sum is:

Q=0.6(5)+0.4(75)=3+30=33

Since the units of the metrics, in this example, are percentages (i.e. the metrics are homogeneous), no normalization is need.

Continuing with the same example, assume that the weights given above were for the demographic “female” and that the weights for the demographic “male” are 0.4 for click-through rate and 0.6 for view-through rate. Then, applying Equation 1 for the receptivity and attentiveness as a weighted sum for the demographic “male”, we obtain:

Q′=0.4(5)+0.6(75)=2+45=47

It can therefore be seen that the BAI for the given receptivity and attentiveness is 33 for females but 47 for males. As a result, advertisements targeting males will be more effective at this receptivity and attentiveness than advertisements for females.

Iterative Updates to Scoring Database

In an example embodiment, the scoring database may be updated on a periodic basis, e.g. every 15 minutes. In this example, central control 60 activates the process 66 to implement the scoring database update process every 15 minutes, drawing from the then-current metrics from metrics database 48 and parameter database 50.

To prevent the quality scores varying widely with each update, the most recent metrics and/or parameters can be averaged with historical metrics and/or parameters. For example, the metrics applied to the scoring database update process can be the average of metrics and parameters during a “window” of time moving forward in 15 minute steps. The window can be chosen to be of sufficient time-length to smooth out any short-term spikes or dips in quality scores but not so long as to understate or overstate the current quality level. For example, the window can be 1-5 days in length.

It should also be noted that second, third, etc. order information can be derived from the iterative collection of metric data. For example, velocity (e.g. speed of change of a metric) and acceleration (e.g. acceleration of change of a metric) can be calculated and input into the scoring database update process.

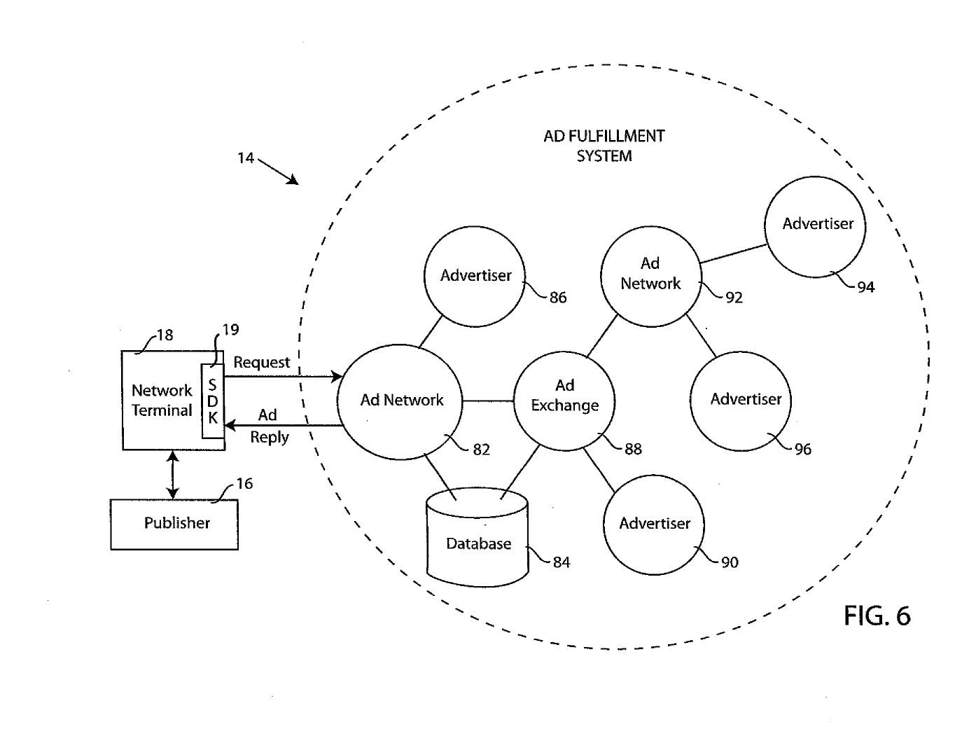

FIG. 6 illustrates, by way of example and not limitation, a user device (a/k/a “network terminal”) 18, a Publisher 16 and an Ad Fulfillment System 14. The user device 18 is a “connected” device in that it communicates with the Publisher 16 and the Ad Fulfillment System 14 via the Internet. In this non-limiting example, user device 18 sends a Request to an Ad Network 82 of Ad Fulfillment System 14 via an SDK, as described in greater detail below. The user device 18, Publisher 16 and various subsystems of the Ad Fulfillment System 14, e.g. Ad Network 82, comprise one or more computer and/or servers 22 (see FIG. 2).

The Ad Network 82 of this example is associated with a database 84. The Ad Network 82 will reply to the user device Request with a Reply (Ad). The Ad Network, in this example, is coupled to one or more Advertisers 86 and to one or more Ad Exchanges 88. The Ad Exchanges, in turn, can be coupled to one or more Advertisers 90, one or more Ad Networks 92, etc.

It will be appreciated that the network of the Ad Fulfillment System 14 can include other computers, databases and servers, e.g. Advertisers 94 and 96 connected to the Ad Network 92. However, at some point latency becomes an issue in that the person using the user device will typically only wait for a short period of time for an advertisement before “clicking out” and moving on to another screen.

It will be further appreciated that, in this non-limiting example, the Ad Network 82 is a gateway for the fulfillment of the ad request by the user device 18. The request to the Ad Network 82 can be accomplished, by way of example, with an ad network SDK (Software Development Kit) 19 which allows the user device to send a request to the URL (Universal Resource Locator) of, in this example, Ad Network 82. The SDK can, for example, be embedded in a player provided to the user device 18 by Publisher 16. A Request will include, as a minimum, the IP address of user device 18 so that the Ad Network 82 may send its Reply. However, the SDK may provide additional information concerning, by way of non-limiting example, the user, the user device, its environment and/or how it is being used to the Ad Network 82 that can be useful in determining an appropriate advertisement to be sent to the user device 18.

When the user device 18 is a computer 18A, or another user device that can support a web browser, part of the Request can include what is known as a “cookie.” A cookie is a relatively small file of information about a user device which may include demographics, personal information, browser history, context and other information or Attributes that can help with the ad selection process. However, cookies are being increasingly disabled and/or blocked for privacy purposes and they are not generally used on user devices (such as many mobile devices) by application programs (“apps”) that don't implement a web browser.

In an embodiment, set forth by way of example and not limitation, software can be provided in each user device 18 which can provide terminal information that can form the basis of a “fingerprint” for that terminal. For example, YuMe, Inc. of Redwood City, Calif. embeds the customized software SDK 59 into user devices such as CTVs, smartphones, tablets and personal computers (PCs) which can provide a variety of information to, for example, their analysis servers 12 or advertisers 14. SDKs can be used to collect valuable real-time, continuous, user device information (“data”) that can be saved and aggregated into a central decision-making engine. By way of non-limiting examples, information that can be derived from a terminal device 18 for the purpose of fingerprinting can include the size of the screen, fonts, the time zone, GPS, operating system versions, what plugins are available, what application the user is currently in, and other features or information that can, for example, be provided to an advertiser 14 as part of an advertisement (“ad”) request.

By way of further non-limiting example, a user device 18 can be defined as a screen user device which has had installed upon it a unique SDK 59 which communicates with a server, such as an analysis server 12 or an advertiser server 14. By using information sent by the SDK for a user device 18 a terminal “fingerprint” can be developed using, for example, configuration settings and other observable characteristics by the SDK. Terminal fingerprinting allows for the identification or re-identification of a visiting terminal for such purposes as authenticating a terminal, to identify a user, to track and correlate a user's activity within and across sessions, and to collect information from which inferences can be drawn about a user.

In an embodiment, set forth by way of example but not limitation, a “terminal fingerprint” can include a homogeneous set of fields that describe a specific user device at a specific point in time. In this example, the fields can be collected via a variety of mechanism. In certain embodiments, missing fields can be considered part of the fingerprint.

It will be appreciated that a fingerprint of a given user device may change over time due to changes in software versions, browser plugins, network configurations etc. To address this fact, prior versions (“historical set”) of a user device's fingerprint may be stored in a database. In a non-limiting example, a new fingerprint preferably matches the most recent fingerprint of the historical set within a certain threshold.

As used herein, a “terminal ID” is preferably a unique, algorithmically generated identification (“ID”) that is assigned to the historical set of terminal fingerprints for a given terminal. A “match probability” reflects the probability that two fingerprints are from the same user device. The match probability can be normalized between the values of 0 and 1, for example, such that two fingerprints are more similar when the probability is closer to 1 and more dissimilar when the probability is closer to 0. A “match threshold” can be defined as the threshold of the match probability above which a fingerprint is considered to be from the same user device. If, for example, multiple fingerprints have a match probability above the threshold then the one with the highest score can be considered to be a match.

Although various examples have been described using specific terms and devices, such description is for illustrative purposes only. The words used are words of description rather than of limitation. It is to be understood that changes and variations may be made by those of ordinary skill in the art without departing from the spirit or the scope of any examples described herein. In addition, it should be understood that aspects of various other examples may be interchanged either in whole or in part. It is therefore intended that the claims be interpreted in accordance with the true spirit and scope of the invention without limitation or estoppel.

What is claimed is:

1. A system for electronically monitoring audience attentiveness and receptiveness comprising:
a network terminal having a first digital processor, a first non-transient computer readable media, and a first network interface, where the first computer readable media includes program instructions executable on the first digital processor for:
collecting user data concerning a running of, and interaction with, content received via the first network interface by a user of the network terminal; and
transmitting the collected user data via the first network interface to an analysis server; and
an analysis server including a second digital processor, a second non-transient computer readable media, and a second network interface, the second computer readable media including program instructions executable on the second digital processor for:
receiving the collected user data via the second network interface;
converting the collected user data into user metrics; and
analyzing the data to create at least one user Brand Affinity Index (BAI) score for the network terminal user.

2. A system for electronically monitoring audience attentiveness and receptiveness as recited in claim 1 further comprising an advertisement (ad) server including a third digital processor, a third non-transient computer readable media, and a third network interface, the third computer readable media including program instructions executable on the third digital processor for sending a video advertisement via the third network interface to the network terminal of the user in accordance with the user BAI score.

3. A system for electronically monitoring audience attentiveness and receptiveness as recited in claim 1 wherein the network terminal is configured by a Software Development Kit (SDK) to store program instructions in the first computer readable media.

4. A system for electronically monitoring audience attentiveness and receptiveness as recited in claim 1 wherein the analysis server comprises one or more servers connected to the Internet.

5. A system for electronically monitoring audience attentiveness and receptiveness as recited in claim 4 wherein the connected user device is one of a CTV, smartphone, tablet and personal computer (PC).

6. A system for electronically monitoring audience attentiveness and receptiveness as recited in claim 1 wherein analyzing the data comprises updating a scoring database by:
(a) retrieving a set of parameters and metrics;
(b) generating one or more scores from the set of parameters and metrics;
(c) storing the one of more scores in the scoring database; and
(d) repeating operations (a)-(d) for until the update is complete.

7. A system for electronically monitoring audience attentiveness and receptiveness as recited in claim 1 further comprising a scoring system controller.

8. A system for electronically monitoring audience attentiveness and receptiveness as recited in claim 7 further comprising a scoring engine coupled to the scoring system controller.

9. A system for electronically monitoring audience attentiveness and receptiveness as recited in claim 8 further comprising at least one database coupled to the scoring system controller.

10. A system for electronically monitoring audience attentiveness and receptiveness as recited in claim 9 further comprising at least one of a metrics database, a parameter database and a scoring database coupled to the scoring system controller.

11. A system for electronically monitoring audience attentiveness and receptiveness as recited in claim 10 further comprising a report generator coupled to the scoring system controller.

12. A method for electronically monitoring audience attentiveness and receptiveness comprising:
collecting user data concerning a running of, and interaction with, content received via the first network interface by a user of the network terminal;
converting the collected user data into user metrics; and
analyzing the data to create at least one user Brand Affinity Index (BAT) score for the network terminal user.

13. A method for electronically monitoring audience attentiveness and receptiveness as recited in claim 12 further comprising sending a video to the network terminal of the user in accordance with the user BAI score.

14. A method for electronically monitoring audience attentiveness and receptiveness as recited in claim 13 wherein analyzing the data comprises updating a scoring database by:
(a) retrieving a set of parameters and metrics;
(b) generating one or more scores from the set of parameters and metrics;
(c) storing the one of more scores in the scoring database; and
(d) repeating operations (a)-(d) for until the update is complete.
